(19) United States
(12) Patent Application Publication
(10) Pub. No.: US 2026/0266958 A1
(43) Pub. Date: Sep. 10, 2026

(54) SENSOR MODULE WITH ENVIRONMENTAL SENSOR

(71) Applicant: Webasto SE, Stockdorf (DE)

(72) Inventor: Magnus SVIBERG, Stockdorf (DE)

(21) Appl. No.: 19/388,486

(22) Filed: Nov. 13, 2025

(30) Foreign Application Priority Data
Nov. 18, 2024 (DE) 10 2024 133 692.7

(51) Int. Cl. G01S 7/481; B60R 11/00; B60R 11/02; G01S 17/931

(52) U.S. Cl. CPC G01S 7/4813; B60R 11/02; G01S 17/931; B60R 2011/004; B60R 2011/0045

(57) ABSTRACT

A sensor module for a motor vehicle, having an environment sensor, a viewing area through which the environment sensor can detect a vehicle environment, a sensor module frame on which the environment sensor is arranged so that it can be extended and retracted between a retracted position and an extended position, a cover arranged on the environment sensor, a surface bracket arranged on the sensor module frame, and a hood arranged at least partially on the surface bracket, which covers and/or spans the surface bracket and the cover and is made of a flexible or elastic or bendable material.

### CROSS-REFERENCE TO RELATED APPLICATION

This application claims the benefit of German Application No. 10 2024 133 692.7, filed Nov. 18, 2024, which is incorporated herein by reference in its entirety.

### TECHNICAL FIELD

The invention relates to a sensor module for a motor vehicle with an environment sensor. The invention also relates to a motor vehicle that comprises at least one such sensor module.

### BACKGROUND

Vehicle roofs are known from practice. A vehicle roof can, for example, be designed as a roof sensor module that can be mounted as a separate unit on the body of a passenger car forming a vehicle shell. As an interface to the vehicle roof, the vehicle body comprises roof rails, which can be designed as longitudinal rails and/or transverse rails and represent a support device on the vehicle shell side. The vehicle roof comprises a roof skin that forms an outer visible surface and has sensor viewing areas through which environment sensors, which serve to detect the vehicle environment and are arranged under the roof skin, can detect the vehicle environment.

Autonomous or semi-autonomous vehicles comprise, for example, a roof designed as a sensor roof module or roof sensor module (RSM), which is equipped with a plurality of environment sensors. The environment sensors, which are integrated into a dry area in the vehicle roof, which is designed in particular as a roof sensor module, and which are designed, for example, as lidar sensors and/or radar sensors and/or cameras, detect the environment around the vehicle and provide corresponding measurement signals to a control electronics system of the vehicle in question, so that the respective traffic situation can be determined and the driving behavior of the vehicle in question can be adapted to this traffic situation. The environment sensors can, for example, be extendable and retractable, or fixed to the roof skin. Furthermore, the integration of various functions for sensor availability, such as cleaning and/or cooling of environment sensors, into such a roof sensor module is known. Extendable and retractable variants of roof sensor modules are also known.

A continuing challenge with such sensor modules and/or roof sensor modules is often inadequate optical design, unattractive appearance, complex layout, and high complexity in the use of installation space for sensor integration. Not least, design and functional limitations in sensor positioning and in the positioning of a field of view to provide high field of view coverage lead to increasingly complex solutions. Further challenges with extendable and retractable sensor modules and/or roof sensor modules are problems with water ingress and water management. To counteract this, complex design solutions are necessary that require a large amount of installation space, which is associated with high weight and high costs.

### SUMMARY

It is an object of the invention to provide an improved sensor module and/or an improved roof sensor module and/or an improved motor vehicle with such a sensor module and/or such a roof sensor module.

The object is achieved by a sensor module with the features of claim 1. Furthermore, the object is achieved by a roof sensor module with the features of claim 10. The object is also achieved by a vehicle with the features of claim 11.

Advantageous embodiments of the invention are the subject of the dependent claims. The invention covers all combinations of at least two features disclosed in the description, the claims, and/or the figures. In particular, it is understood that linguistic modifications and/or substitutions of respective terms within the scope of normal linguistic practice, in particular the use of synonyms supported by generally accepted linguistic literature, are included in the present disclosure without being explicitly mentioned in their respective formulations.

In a first aspect, a sensor module for a motor vehicle is proposed. The sensor module has an environment sensor, a viewing area through which the environment sensor can detect a vehicle environment, a sensor module frame on which the environment sensor is arranged so that it can be extended and retracted between a retracted position and an extended position, a cover arranged on the environment sensor, a surface bracket arranged on the sensor module frame, and a hood arranged at least partially on the surface bracket, which covers and/or spans the surface bracket and the cover and is made of a flexible or elastic or bendable material.

The hood can also be understood as a soft top or canopy. The hood is movable between the retracted position and the extended position, in particular in the manner of a convertible top, and in each case defines an outer contour of the sensor module. In the extended position, the hood preferably merges smoothly and continuously into the surrounding surface component of the vehicle roof so that no hard contours or edges are visible.

It is understood that the sensor module may have at least one environment sensor. It is understood that the sensor module may have further functional components, in particular an air conditioning device for air conditioning the environment sensor and/or a lighting device and/or a cleaning device with at least one cleaning nozzle. Such functional components may be arranged on the sensor module frame. The environment sensor may comprise a lidar sensor and/or a radar sensor and/or an ultrasonic sensor and/or an infrared sensor and/or a camera sensor. The environment sensor may be fixed relative to a surface component or roof skin of the motor vehicle, or may be retractable and extendable or adjustable. In this context, the term “motor vehicle” is used synonymously with the term “vehicle.”

The present sensor module improves the styling and design of the motor vehicle. Furthermore, the present sensor module can improve the layout or utilization of space in the motor vehicle. Improved sensor positioning and a corresponding improvement in the field of view and visibility of the environment sensor are also possible. This can also improve the sensor availability functions. Due to its design, the sensor module also has improved water resistance and water management. Overall, the sensor module has reduced complexity, which lowers the costs required for the sensor module. The present design also saves weight.

In a further aspect, it is proposed that the cover be fixed to an upper side of the environment sensor and be extendable and retractable with the environment sensor between the retracted position and the extended position, wherein the surface bracket is fixed to the sensor module frame and wherein the hood is fixed at least in sections to the edge of the surface bracket.

Both the cover and the surface bracket are preferably made of immovable or fixed or rigid profiles or profile sections, for example made of plastic or metal (e.g., sheet metal). The cover and the surface bracket define the shape of the sensor module. The transitions are then smoothed by means of the hood in order to create an aesthetic overall impression.

In a further aspect, it is proposed that the environment sensor can be extended and retracted between the retracted position and the extended position relative to the sensor module frame by means of a mechanism that is arranged in particular on the sensor module frame and by means of an actuator.

The mechanism may be any adjustment kinematics suitable for adjusting the environment sensor between the retracted position and the extended position. The actuator may be a rotary drive or a linear drive.

In a further aspect, it is proposed that the hood has the viewing area at least in some areas and/or that the viewing area is arranged on the hood or integrated into the hood.

Several viewing areas may also be provided on or in the hood. The viewing area may be formed integrally with the hood or inserted into an opening in the hood in the manner of a window. The viewing area may have or may form a lens or an objective.

In a further aspect, it is proposed that the hood is flush with a vehicle roof of the motor vehicle in the retracted position, and wherein the hood defines a protrusion relative to the vehicle roof in the extended position.

The surface bracket has a shape that preferably corresponds at least in part to a predetermined shape of an outer surface of the sensor module. The cover is arranged or (permanently) mounted on the at least one environmental sensor. The cover preferably has a shape that corresponds at least in sections to a predetermined shape of the outer surfaces of the sensor module. Together, the cover and the surface bracket preferably form an almost complete shape of the predetermined outer surfaces of the sensor module. The hood is mounted or stretched over the surface bracket and the cover. The hood defines the complete predetermined outer surface of the sensor module.

In a further aspect, it is proposed that the sensor module also has a cone which is arranged in an area around the viewing area and which is preferably attached at least in sections to the cover and/or the sensor module frame and/or the surface bracket and/or the environment sensor, wherein the cone is stowed below the hood in the retracted position of the environment sensor and, in the extended position of the environment sensor, provides a field of view for the environment sensor through the viewing area, and wherein the cone is preferably made of a flexible or elastic or bendable material.

The cone can be made of a textile or a film. The cone is shaped, for example, in the manner of a truncated hollow cone. On one side, the cone is then preferably attached to the environment sensor around the viewing area. On the other side, the cone is attached, for example, to the cover (at an edge area of the cover) and the sensor module frame and/or the surface bracket.

In a further aspect, it is proposed that the sensor module also has a flap and a cleaning module with at least one cleaning nozzle, wherein the flap is preferably adjustable by an actuator in order to release and/or activate the cleaning module.

The actuator can preferably also be actuated by means of fluid pressure from a cleaning medium and, for example, also comprise a return spring.

In a further aspect, it is proposed that further covers are arranged in particular in a hinged manner on the cover, wherein the further covers are preferably each mounted in a hinged manner on the sensor module frame and/or the surface bracket.

The additional covers may be a front cover, a rear cover, and side covers. These additional covers preferably provide additional support for the hood in both positions and are mechanically actuated, for example, by the mechanism of the environment sensor. The additional covers may also be mounted on the surface bracket and/or the sensor module frame in a sliding manner.

In a further aspect, it is proposed that the hood comprises a flexible or elastic or bendable film and/or a flexible or elastic or bendable textile, and/or wherein the hood is at least partially transparent or colored.

A wide variety of hood designs are conceivable and can be manufactured. Some designs are explained in more detail below.

The present invention also claims a vehicle roof of a motor vehicle comprising at least one sensor module according to any embodiment.

A preferred embodiment of the vehicle roof is designed as a roof sensor module. Such a roof sensor module forms an integrated structural unit that accommodates components required for autonomous or semi-autonomous driving of the vehicle in question. The roof sensor module, in which a plurality of functional elements can be integrated, thus represents a compact structural unit which, on the part of a vehicle manufacturer, is connected to a vehicle body or a vehicle shell comprising roof rails, such as roof side rails and/or roof longitudinal rails. The vehicle roof designed as a roof sensor module thus represents a sensor roof module or roof sensor module (RSM) that enables autonomous or semi-autonomous driving of the vehicle in question.

A motor vehicle equipped with such a vehicle roof and designed as an autonomous vehicle drives independently in autonomous driving mode, at least without significant intervention by a driver. In a semi-autonomous driving mode, the vehicle roof according to the invention forms, for example, part of a driver assistance system.

The vehicle roof may be provided with a transparent fixed roof section and/or a roof opening system for opening the roof.

In particular, the vehicle roof forms at least part of the roof of a passenger car. However, it can also be the roof of a commercial vehicle, which can be designed, for example, as a delivery van, a bus, an autonomous minibus, such as a so-called people mover, or even a truck tractor.

The present invention also relates to a motor vehicle comprising a sensor module and/or a vehicle roof of the type described above. The vehicle roof preferably forms a roof sensor module (RSM) which can be arranged as a pre-assembled unit on a vehicle body of the motor vehicle. In other words, a vehicle body shell of the motor vehicle can be provided with a prefabricated or pre-assembled roof sensor module, which is designed as a sensor roof module or roof sensor module.

It goes without saying that the designs and exemplary embodiments mentioned above and to be explained below can be formed not only individually but also in any combination with each other without departing from the scope of the present invention. It is also understood that the designs and exemplary embodiments mentioned above and to be explained below refer to all embodiments of the invention in an equivalent or at least similar manner without being mentioned separately in each case.

### BRIEF DESCRIPTION OF DRAWINGS

Embodiments of the invention are schematically represented in the drawings and are explained below by way of example.

FIG. 1 shows a schematic view of a motor vehicle with a vehicle roof on which a sensor module is arranged.

FIG. 2 shows a schematic view of a motor vehicle with a vehicle roof on which a sensor module is arranged.

FIG. 3 shows an exemplary embodiment of a sensor module.

FIG. 4 shows an exemplary embodiment of a sensor module.

FIG. 5 shows an example of a sensor module design.

FIG. 6 shows an exemplary embodiment of a sensor module design.

FIG. 7 shows an exemplary embodiment of a sensor module.

FIG. 8 shows an exemplary embodiment of a sensor module.

FIG. 9 shows an exemplary embodiment of a sensor module.

FIG. 10 shows an exemplary embodiment of a sensor module.

FIG. 11 shows an exemplary embodiment of a sensor module.

FIG. 12 shows an exemplary embodiment of a sensor module.

FIG. 13 shows an exemplary embodiment of a sensor module.

FIG. 14 shows an exemplary embodiment of a sensor module.

FIG. 15 shows an exemplary embodiment of a sensor module.

FIG. 16 shows an exemplary embodiment of a sensor module.

FIG. 17 shows an exemplary embodiment of a sensor module.

FIG. 18 shows an exemplary embodiment of a sensor module.

FIG. 19 shows an exemplary embodiment of a sensor module.

FIG. 20 shows an exemplary embodiment of a sensor module.

FIG. 21 shows exemplary embodiments of hoods.

FIG. 22 shows an exemplary embodiment of a sensor module.

FIG. 23 shows an exemplary embodiment of a hood.

FIG. 24 shows an exemplary embodiment of a hood.

### DETAILED DESCRIPTION

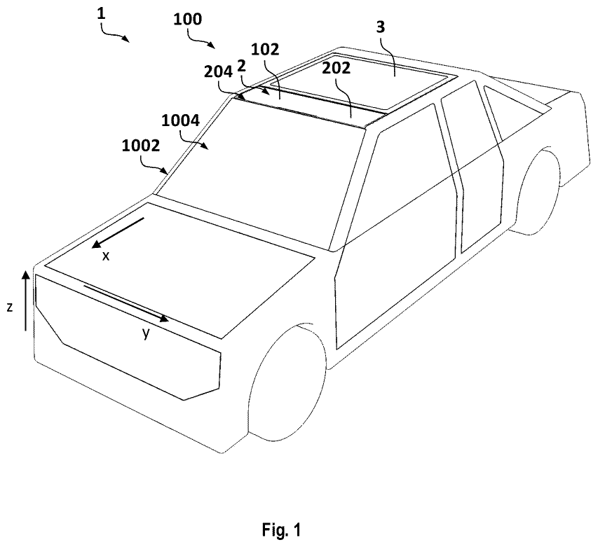

FIG. 1 schematically shows a motor vehicle 1 having a vehicle body 1002. Furthermore, the motor vehicle 1 has a roof sensor module 2 which is arranged as a pre-assembled unit on the vehicle body 1002 and forms at least part of a vehicle roof 100 of the motor vehicle 1. The motor vehicle 1 also has a windshield 1004.

The motor vehicle 1 defines a vehicle longitudinal direction x that runs orthogonally to a vehicle width direction y and a vehicle height direction z.

In alternative embodiments, the vehicle roof 100 may also be a vehicle roof that is not designed as a roof sensor module 2. Thus, all embodiments also refer to such a vehicle roof 100.

The roof sensor module 2 comprises a surface component 202 which, at least in some areas, forms a roof skin 102 of the vehicle roof 100. According to FIG. 1, the roof sensor module 2 comprises a sunroof and/or panoramic roof 3. The sunroof and/or panoramic roof 3 may have a roof opening system (not shown) which, for example, comprises a cover element that can be moved to selectively open or close a roof opening. In other or supplementary embodiments, the roof sensor module 2 may have a fixed roof element.

The motor vehicle 1 and/or vehicle roof 100 and/or the roof sensor module 2 has/have a sensor module 204. In the present case, the sensor module 204 is part of the roof sensor module 2. The sensor module 204 may also be designed separately from the roof sensor module 2. The sensor module 204 is shown in detail in the further figures in at least partially different embodiments. In the present case, the roof sensor module 2 or the sensor module 204 is/are designed as a fully functional and ready-to-install pre-assembly module that is attached to the vehicle body 1002 (e.g., by gluing or screwing). The roof sensor module 2 comprises the sunroof and/or panoramic roof 3, which is attached to the vehicle 1 together with the roof sensor module 2, for example. Alternatively, the sunroof and/or panoramic roof 3 (if present) may be mounted separately on the vehicle 1.

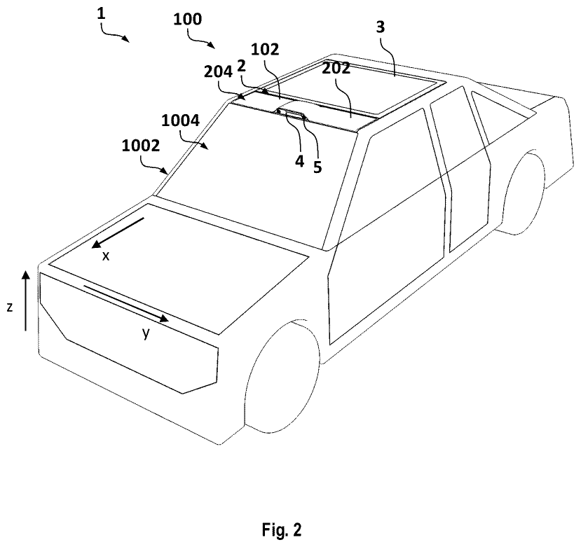

The sensor module 204 has a viewing area 4 and at least one environment sensor 5, which can detect the vehicle's surroundings through the viewing area 4 (see FIG. 2). The environment sensor 5 can be moved between a retracted position (see FIG. 1) and an extended position (see FIG. 2). The sensor module 204 or the roof sensor module 2 comprises/comprise a cover 6, a mechanism 7, a cleaning module 9, an actuator 10, a hood 11, a surface bracket 12, and a sensor module frame 13.

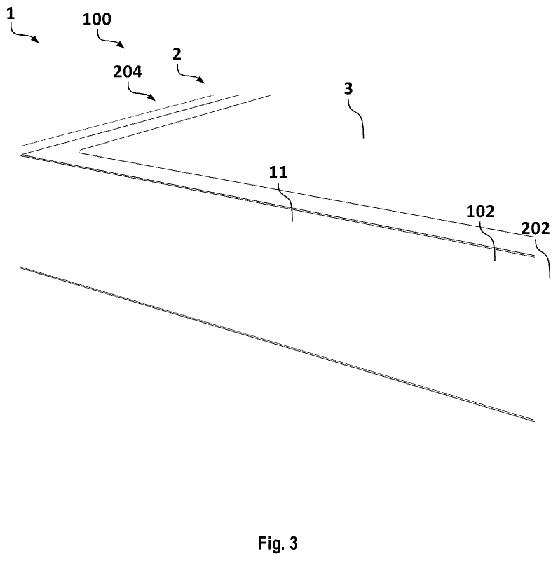

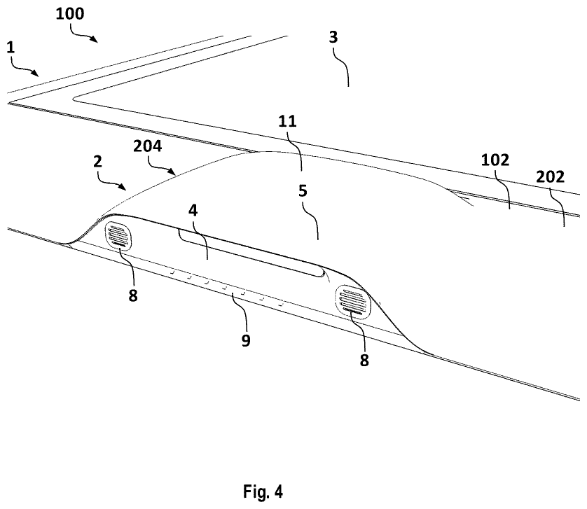

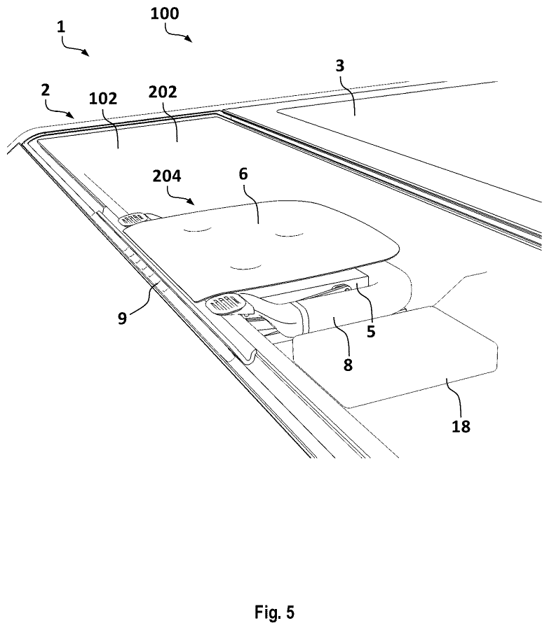

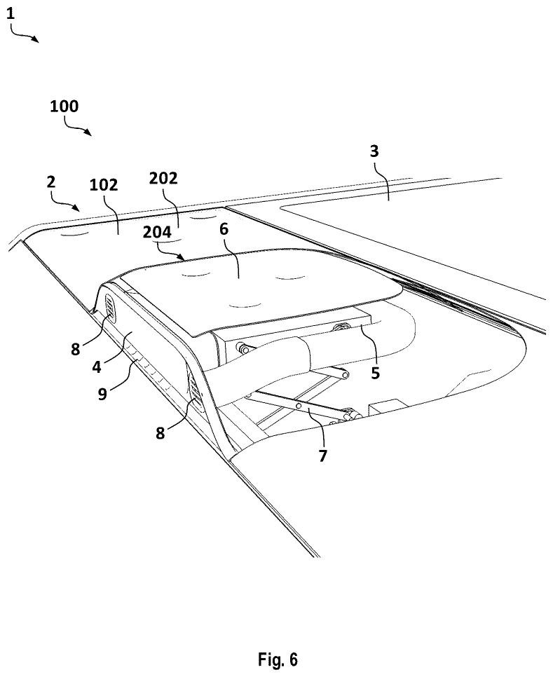

The at least one environment sensor 5 can be moved between the closed or retracted position and the open or extended position by the mechanism 7, which can be actuated, for example, by the actuator 10. FIGS. 3 and 4 show the sensor module 204 and the roof sensor module 2 in a retracted position (FIG. 3) and an extended position (FIG. 4), respectively. FIGS. 5 and 6 show the roof sensor module 2 and the sensor module 204, respectively, in a retracted position (FIG. 5) and an extended position (FIG. 6). The hood 11 is shown as transparent.

The mechanism 7 comprises or enables, for example, a holding and/or locking function for the at least one environment sensor 5. Such a holding and/or locking function allows the at least one environment sensor 5 to be fixed, preferably in the retracted position and/or in the extended position, at least temporarily. In one example, the mechanism 7 is a multiple-joint kinematic mechanism with a spindle drive electric motor. The spindle drive electric motor serves as the actuator 10. In other alternatives, the mechanism 7 may also have single hinges and/or sliders and/or four-joint hinges. In other alternatives, the actuator 10 may also comprise at least one (rotary) electric motor and/or a pneumatic drive and/or a magnetic drive, etc.

The sensor module frame 13 carries other modules and components, such as the heating/cooling module 8 and/or the cleaning module 9. The cleaning module 9 may comprise at least one cleaning nozzle and/or a nozzle strip. The surface bracket 12 is arranged on the sensor module frame 13. The surface bracket 12 has a shape that preferably corresponds at least in part to a predetermined shape of an outer surface of the sensor module 204. The cover 6 is arranged or (permanently) mounted on the at least one environment sensor 5. The cover 6 preferably has a shape that corresponds at least in sections to a predetermined shape of the outer surfaces of the sensor module 204. Together, the cover 6 and the surface bracket 12 preferably form an almost complete shape of the predetermined outer surfaces of the sensor module 204. The hood 11 is mounted or stretched over the surface bracket 12 and the cover 6. The hood 11 defines the complete predetermined outer surface of the sensor module 204. The outer surface thus also forms the outer skin of the vehicle roof 100 of the motor vehicle 1. Several possibilities for implementing the hood 11 are described in more detail below.

When the roof sensor module 2 or the sensor module 204 is retracted, the outer surfaces are preferably perfectly adapted to the surface component 202 of the vehicle 1 forming the roof skin 102. In this position, the outer surfaces of the roof sensor module 2 or sensor module 204 are preferably flush with the surrounding surface component 202, so that no roof sensor module 2 or sensor module 204 is visible. When the roof sensor module 2 or sensor module 204 is extended, the hood 11 preferably takes on a new shape so that the at least one environment sensor 5 can be extended.

The present invention shows embodiments in which a front edge of the cover 6 and the surface bracket 12 extends to a front side of the roof sensor module 2 and therefore to an interface or dividing line between the roof sensor module 2 and the surrounding vehicle body 1002, defined in particular by an upper edge of the windshield 1004. When the roof sensor module 2 or the sensor module 204 is extended, the viewing area 4 and, for example, at least some components of the heating and/or cooling module 8 and/or at least some components of the cleaning module are also activated, in particular becoming visible and functional. When the roof sensor module 2 or the sensor module 204 is retracted, these components or modules are not visible and are stowed beneath the roof skin.

Furthermore, the roof sensor module 2 or sensor module preferably has a cone 14. When the roof sensor module 2 or sensor module 204 is extended, the cone 14, which is preferably separate and made of a flexibly movable material, fills an (intermediate) space between the cover 6, the surface bracket 12, the sensor module frame 13, and the environment sensor 5. During the extension movement, parts of the heating/cooling module 8 are also exposed and/or integrated, for example. In the retracted position of the sensor module 204, the cone 14 is preferably arranged below the cover 6 and the hood 11 so that it is not visible from the outside, or is covered by them.

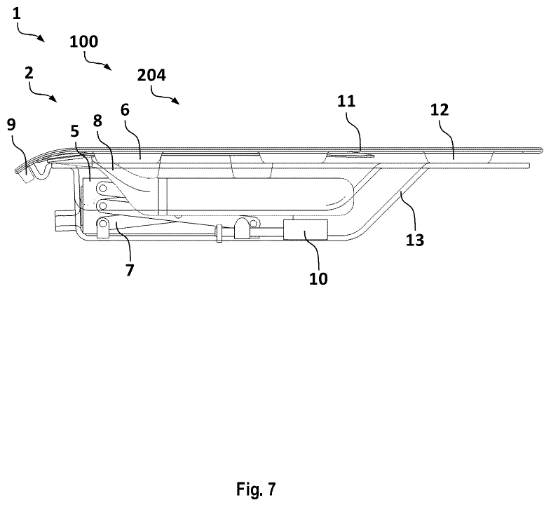

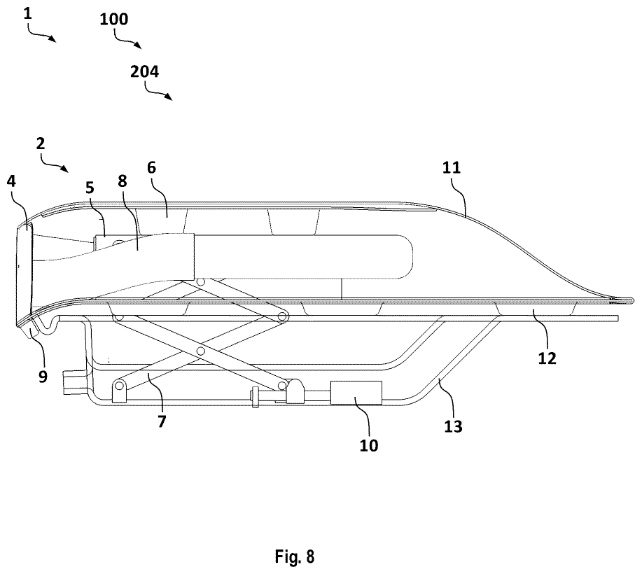

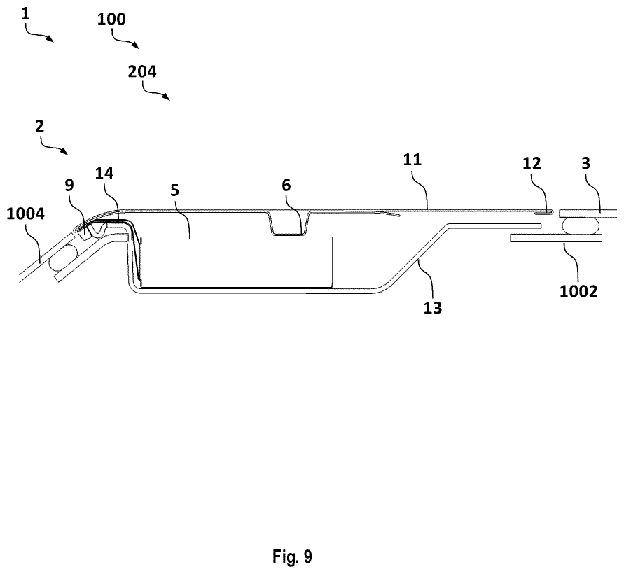

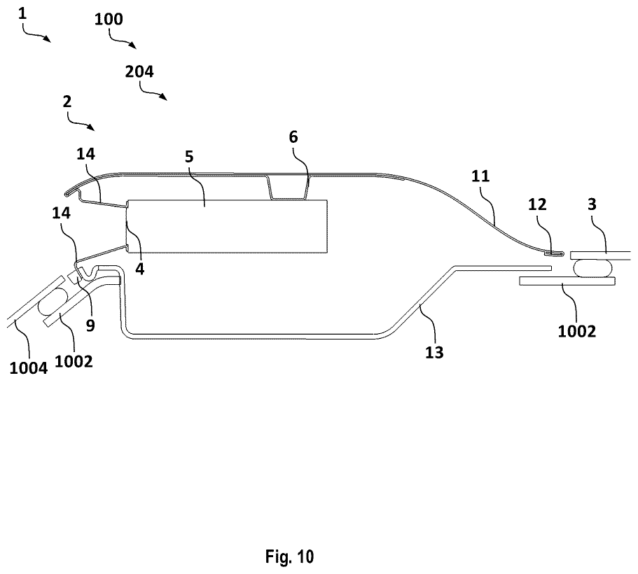

FIGS. 7 and 8 show the roof sensor module 2 and the sensor module 204 in a retracted position (FIG. 7) and in an extended position (FIG. 8), respectively. Here, the hood 11 and the sensor module frame 13 are shown to be at least partially transparent. FIGS. 9 and 10 show the roof sensor module 2 and the sensor module 204 in a retracted position (FIG. 9) and in an extended position (FIG. 10), respectively. A respective section in the x-z plane at y=0 is shown. In this example, the heating and/or cooling module 8 is implemented by means of an outside air supply, which is sucked in, for example, through a grille that can be arranged in the cone 14 next to the sensor and conducted through an at least partially flexible and at least partially rigid air duct through a heat exchanger and an electric fan through another at least partially rigid and partly flexible air duct to another grille, which returns the air to the outside. Other cooling solutions, such as the use of interior air with at least one grille inside the vehicle, are also possible.

In the example shown, the cleaning module 9 is implemented with high-pressure liquid and/or air, which can be applied to the viewing area 4, for example, by cleaning nozzles or a nozzle bar not shown in detail. Of course, valves for controlling and directing the liquid and/or air, generally a cleaning medium, can be provided, which direct the cleaning medium from a tank in the vehicle, for example through hoses, to the cleaning nozzles.

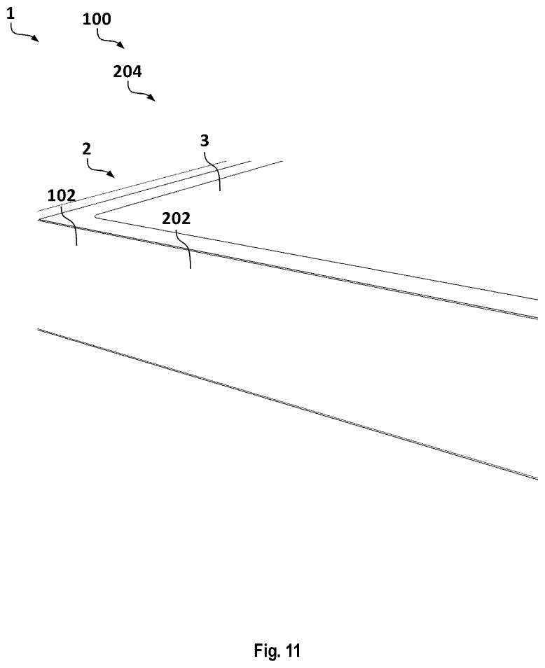

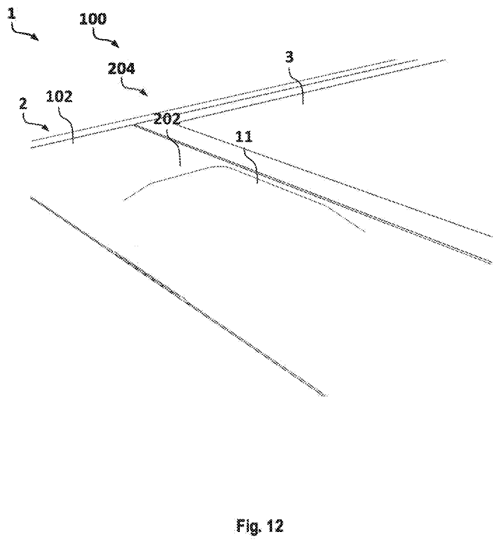

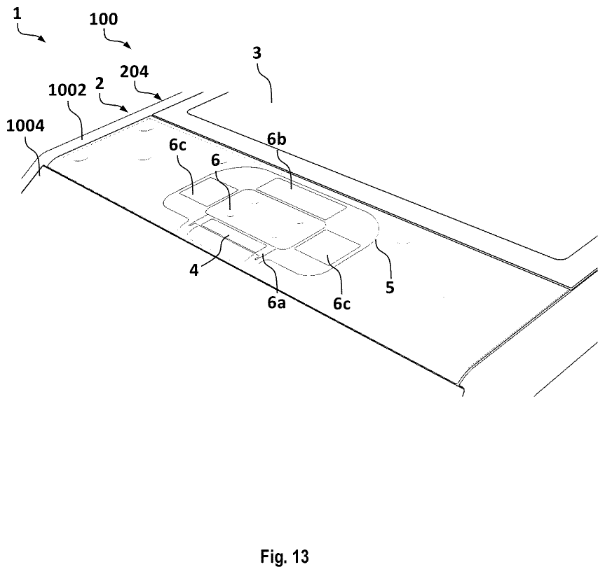

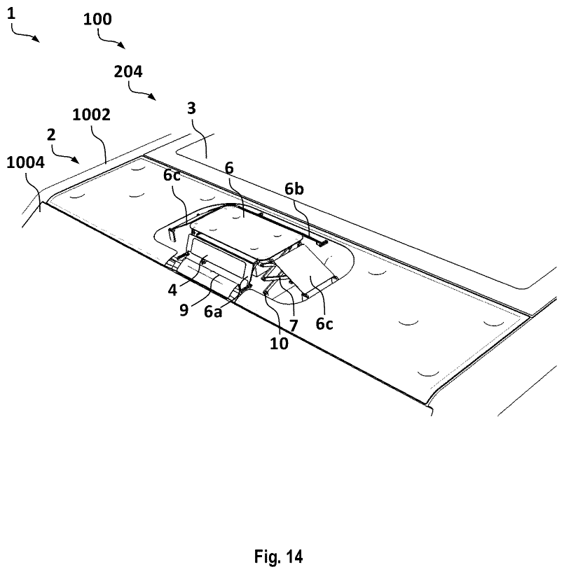

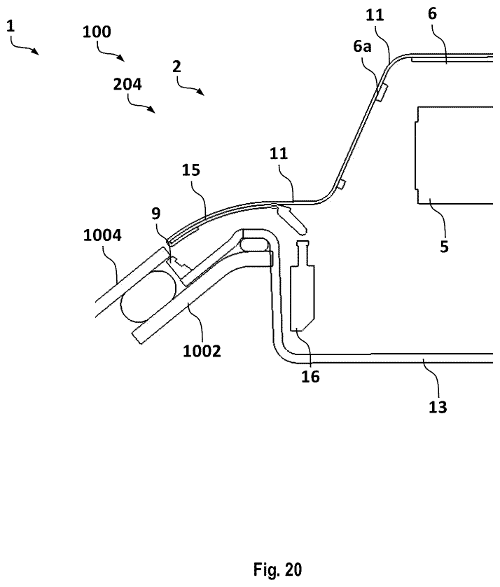

FIGS. 11 to 20 show an alternative embodiment of the sensor module 204. FIGS. 11 and 12 show the sensor module 204 and the roof sensor module 2 in a retracted position (FIG. 11) and in an extended position (FIG. 12), respectively. FIGS. 13 and 14 show the roof sensor module 2 and the sensor module 204, respectively, also in a retracted position (FIG. 13) and in an extended position (FIG. 14), but with the hood 11 shown as transparent.

Additional movable covers 6a, 6b, 6c (front, rear, and side) are arranged between the (main) cover 6 and the surface bracket 12. These additional covers 6a, 6b, 6c provide additional support for a canopy of the sensor module 204 in both positions and are actuated mechanically, for example, by the mechanism 7 of the environment sensor 5. For example, the additional covers 6a, 6b, 6c can be hinged or pivotably mounted to the cover 6 and can thus move relative to the surface bracket 12. Overall, these covers 6, 6a, 6b, 6c and the surface bracket 12 form an almost complete shape of the predetermined outer surfaces in both positions. The hood 11 is also mounted or stretched over the surface bracket 12 and the covers 6, 6a, 6b, 6c, completely forming the desired outer surfaces of the roof sensor module 2 or the sensor module 204 and therefore of the vehicle 1. The possibilities for implementing the hood 11 are described below.

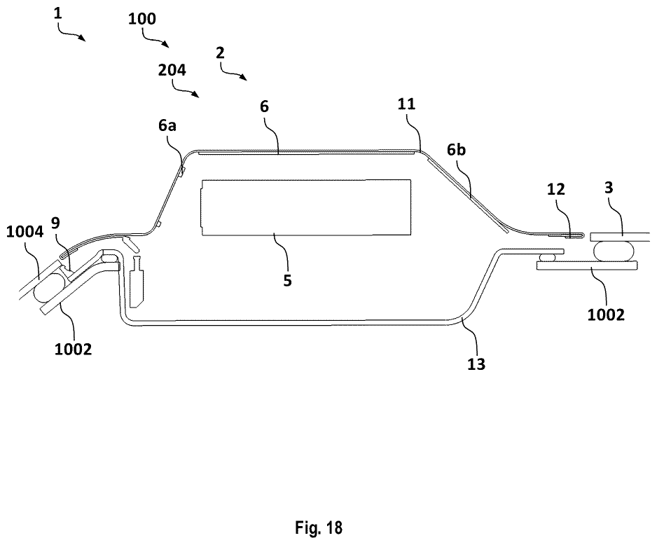

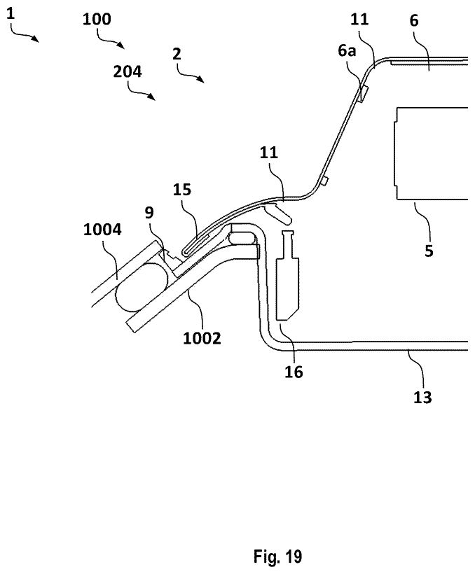

Furthermore, a flap 15 is arranged along the front edge of the roof sensor module 2 in front of the environment sensor 5. The flap 15 can be adjusted between a closed position and a lowered position. The flap 15 is pivotably mounted on the sensor module frame 13 and is operated, for example, by an actuator 16, e.g., an electric linear drive. Other solutions are also possible. The hood 11 is attached to the flap 15 and, when the flap 15 is closed, forms the desired outer surface of the roof sensor module 2. When the flap 15 is lowered, the hood 11 is at least partially lowered and exposes the cleaning module 9. In FIGS. 18 and 19, for example, a nozzle strip mounted on the sensor module frame 13 is exposed. The front edge of flap 15 and surface bracket 12 extends, for example, to the front of roof sensor module 2 and therefore to the interface (separation line) between roof sensor module 2 and vehicle 1 (here realized as the upper edge of windshield 1004). When the roof sensor module 2 is extended, the environment sensor 5 and, in this case, the heating and/or cooling module 8 (components) are activated, i.e., they become visible and functional. The cleaning module 9 is preferably activated when the flap 15 is lowered. When the roof sensor module 2 is retracted and the flap 15 is closed, these are not visible.

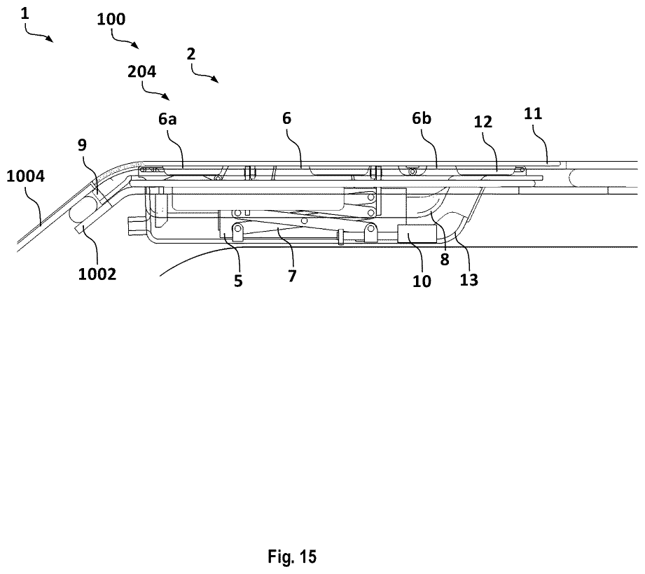

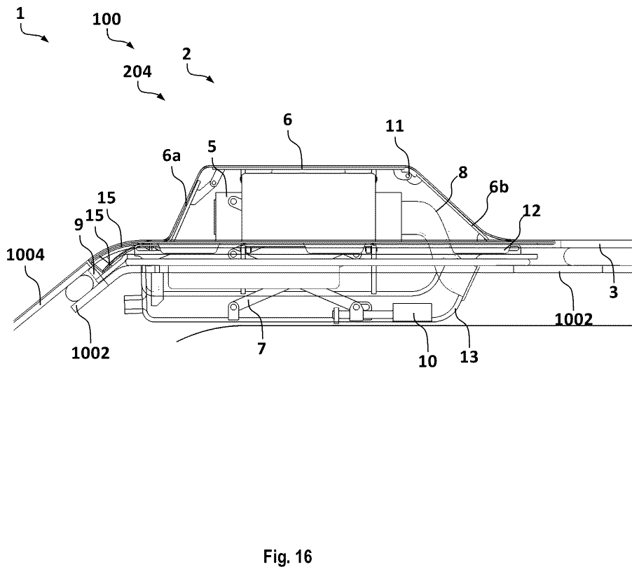

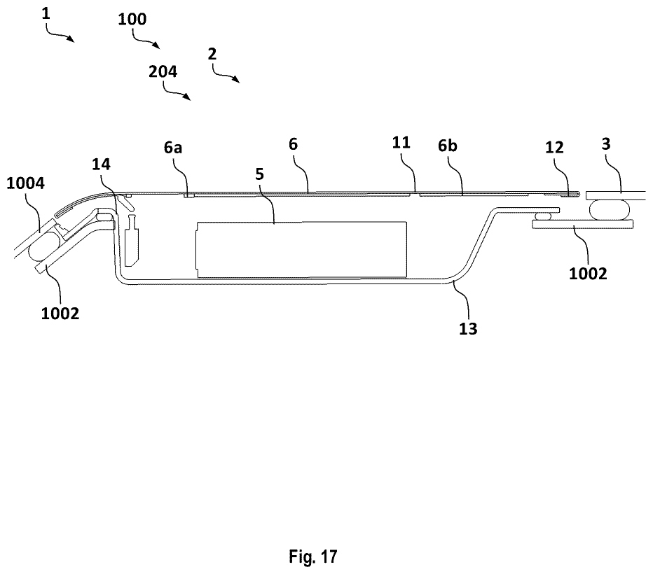

FIGS. 15 and 16 show the roof sensor module 2 and the sensor module 204 in a retracted position (FIG. 15) and in an extended position (FIG. 16), respectively. The hood 11 and the sensor module frame 13 are shown to be transparent at least in some areas. FIGS. 17 and 18 show the roof sensor module 2 and the sensor module 204 in a retracted position (FIG. 17) and in an extended position (FIG. 18), respectively. A respective section in the x-z plane at y=0 is shown.

In principle, a different type of actuation can also be used for the flap 15. For example, pressure from the cleaning module 9 can be used to first actuate a cylinder/piston, which lowers the flap 15 and then supplies the cleaning nozzle (or nozzle bar) with a pressure/volume flow of cleaning medium.

The functions of the roof sensor module 2 and/or the sensor module 204, including the mechanism 7, the heating and/or cooling module 8 and/or the cleaning module 9 and/or the flap 15, are controlled, for example, by an electronic control unit 18, which also handles communication with the vehicle 1, for example.

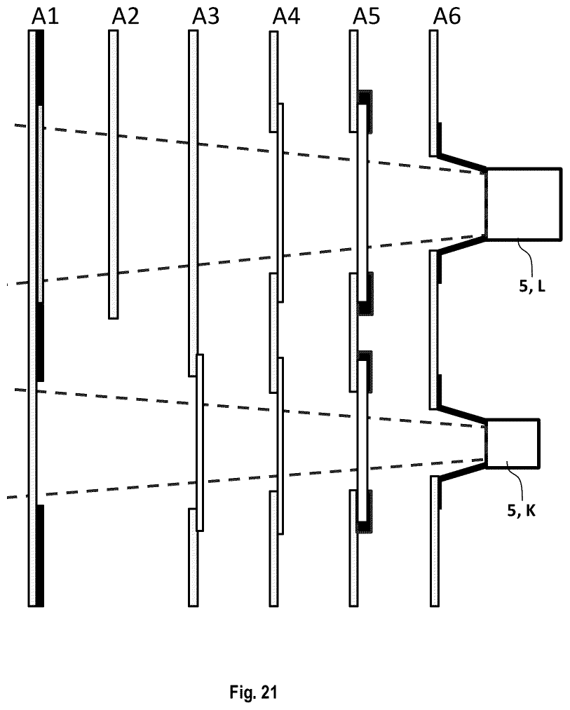

The hood 11 can be implemented in various ways, as shown in FIG. 21, for example. In a variant A1, the hood 11 can be formed by a flexible and/or stretchable film. The film can be transparent and can be arranged, for example, on a black carrier film. In this case, in the area of the viewing area 4 of the environment sensor 5, in particular a lidar L, the carrier film is at least partially removed and, if necessary, a separate transparent, possibly colored (e.g., black) sensor film is used. In the viewing area 4 of another environment sensor 5, for example a camera K, the carrier film can be at least partially removed.

In a variant A2, the hood 11 can be designed as a flexible and stretchable colored (e.g., black) film. The film can be sensor-transparent (e.g., for the lidar L) but colored (e.g., black).

In a variant A3, the hood 11 can be formed by a flexible and, if necessary, stretchable colored (e.g., black) film. The film can be sensor-transparent (e.g., for lidar L) but colored (e.g., black). In the viewing area 4 for, e.g., the camera K, the colored film can be at least partially removed and a separate transparent film can be used.

In variant A4, the hood 11 can be made of a flexible, optionally stretchable, possibly colored (e.g., black) textile. In the sensor window for, e.g., the lidar L, the textile can be partially removed and a separate transparent, possibly colored (e.g., black) film can be used. In the viewing area 4 for, e.g., the camera K, the textile can be at least partially removed and a separate transparent film can be used.

In a variant A5, the hood 11 can be made of a flexible, optionally stretchable, colored (e.g., black) textile. In the viewing area 4 for, e.g., Lidar L, the textile can be at least partially removed and a separate frame and a transparent, possibly colored (e.g., black) sensor lens, in particular in a rigid arrangement, can be used. In the viewing area 4 for, e.g., camera K, the textile can be at least partially removed and a frame and a transparent lens, in particular in a rigid arrangement, can be used.

In a variant A6, the hood 11 can be formed by a flexible, optionally stretchable, possibly colored (e.g., black) textile, in the viewing area 4 for, e.g., the lidar L and/or the camera K, the textile can be at least partially removed and a separate flexible cone (e.g., made of textile) can be used between an opening in the textile of the hood 11 and the environment sensor 5, thereby preferably exposing a sensor lens.

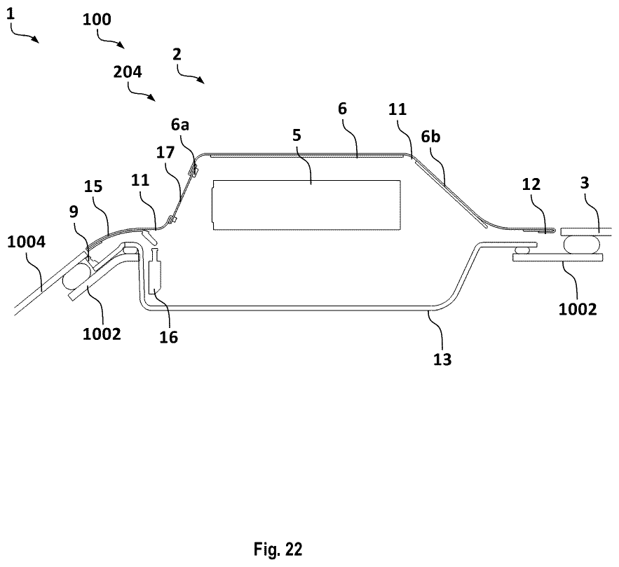

FIG. 22 shows a design with a viewing area 17 fixed in the hood 11. The viewing area 17 is arranged or movably mounted on a front edge of the cover 6.

Other designs are also conceivable.

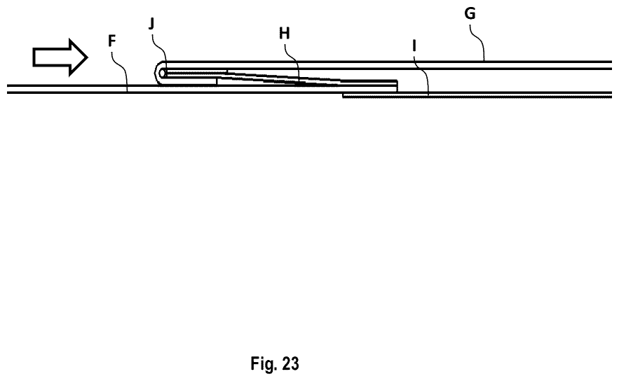

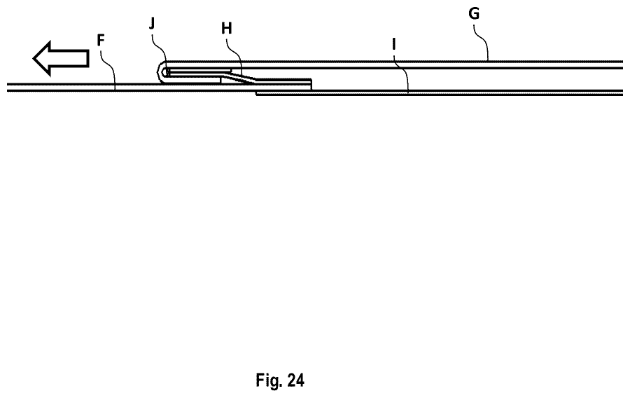

FIGS. 23 and 24 each show an example of the implementation of the hood 11 with two layers of non-stretchable textiles F, G with a stretchable textile H in between, as well as an optional additional stretchable textile I with a tension wire J to enable changes in the shape of the canopy even with non-stretchable materials.

### LIST OF REFERENCE SIGNS

1 motor vehicle
2 roof sensor module
3 sunroof and/or panoramic roof
4 viewing area
5 ambient sensor
6 cover
6a, 6b, 6c cover
7 mechanism
8 heating and/or cooling module
9 cleaning module
10 actuator
11 hood
12 surface bracket
13 sensor module frame
14 cone
15 flap
16 actuator for flap
17 viewing area
18 electronic control unit
100 vehicle roof
102 roof skin
202 surface component
204 sensor module
1002 vehicle body
1004 windshield
x vehicle longitudinal direction
y vehicle width direction
z vehicle height direction

1. A sensor module for a motor vehicle, having:
an environment sensor,
a viewing area through which the environment sensor detects a vehicle environment,
a sensor module frame on which the environment sensor is arranged so that it is extended and retracted between a retracted position and an extended position,
a cover arranged on the environment sensor,
a surface bracket arranged on the sensor module frame, and
a hood arranged at least partially on the surface bracket, which covers and/or spans the surface bracket and the cover and is made of a flexible or elastic or bendable material.

2. The sensor module as claimed in claim 1, wherein the cover is fixed to an upper side of the environment sensor and is extendable and retractable with the environment sensor between the retracted position and the extended position, wherein the surface bracket is fixed to the sensor module frame, and wherein the hood is fixed at least in sections to the edge of the surface bracket.

3. The sensor module as claimed in claim 1, wherein the environment sensor is extended and retracted between the retracted position and the extended position relative to the sensor module frame by a mechanism that is arranged on the sensor module frame and by an actuator.

4. The sensor module as claimed in claim 1, wherein the hood has the viewing area at least in some areas, and/or wherein the viewing area is arranged on the hood or integrated into the hood.

5. The sensor module as claimed in claim 1, wherein the hood is flush with a vehicle roof of the motor vehicle in the retracted position, and wherein the hood defines a protrusion relative to the vehicle roof in the extended position.

6. The sensor module as claimed in claim 1, wherein the sensor module also has a cone which is arranged in an area around the viewing area and which is attached at least in sections to the cover and/or the sensor module frame and/or the surface bracket and/or the environment sensor, wherein the cone is stowed below the hood in the retracted position of the environment sensor and, in the extended position of the environment sensor, provides a field of view for the environment sensor through the viewing area, and wherein the cone is made of a flexible or elastic or bendable material.

7. The sensor module as claimed in claim 1, wherein the sensor module also has a flap and a cleaning module with at least one cleaning nozzle, wherein the flap is adjustable by an actuator to release and/or activate the cleaning module.

8. The sensor module as claimed in claim 1, wherein further covers are arranged in a hinged manner on the cover, wherein the further covers are each mounted in a hinged manner on the sensor module frame and/or the surface bracket.

9. The sensor module as claimed in claim 1, wherein the hood comprises a flexible or elastic or bendable film and/or a flexible or elastic or bendable textile, and/or wherein the hood is at least partially transparent or colored.

10. A vehicle roof of a motor vehicle, comprising at least one sensor module as claimed in claim 1.

11. A motor vehicle, comprising a sensor module as claimed in claim 1.

12. The motor vehicle of claim 11, wherein a vehicle roof forms the roof sensor module which is arranged as a pre-assembled unit on a vehicle body of the motor vehicle.

13. The vehicle roof of claim 10, wherein the vehicle roof forms the roof sensor module configured to be arranged as a pre-assembled unit on a vehicle body of the motor vehicle.
